(19) United States
(12) Patent Application Publication
(10) Pub. No.: US 2011/0057081 A1
(43) Pub. Date: Mar. 10, 2011

(54) Fastening Member of a Street Light Device

(75) Inventors: Fuh-Yuarn Shiau, Hsinchu City (TW); Chin-Chun Wu, Sihu Township (TW)

(73) Assignee: THERMOSHUTTLE CO., LTD., Tao Yuan (TW)

(21) Appl. No.: 12/772,400

(22) Filed: May 3, 2010

(30) Foreign Application Priority Data
Sep. 7, 2009 (TW) 98216464

(51) Int. Cl. F21V 21/088

(52) U.S. Cl. 248/219.4

(57) ABSTRACT

A fastening member for firmly fasten a street light device on a lamp post is disclosed, The fastening member comprises a sleeve formed integrated with a lower cover of said street light device, an upper jaw, a lower jaw and a plurality of bolts. The sleeve formed with a plurality of first thread-holes and a first through-hole at an upper portion and a plurality of second through-holes and a second thread-hole at a lower portion therein. The upper jaw and the lower jaw are placed in the hollow of the sleeve and preinstalled in by using the bolts screwed the thread-holes of the upper jaw and the lower jaw. Another bolts screwed on the first-thread-holes and the second thread-hole in advance. While installing the light device on the lamp post, the bolts screwed on the first-thread-holes and the second thread-hole are tighten.

### BACKGROUND OF THE INVENTION

1. Field of the Invention

The present invention relates to a street LED (Light Emitting Diodes) lighting device, particularly to a street LED lighting device having a sleeve integrated thereof housing an upper jaw and the lower jaw to firmly fasten on the bent end of the lamp post.

2. Description of the Prior Art

Conventional street lamps are mostly either halogen or mercury lamps attached on the bent end of a lamp post. The lamp apparatus usually contains one or more than one halogen lamp or light emitting component, along with a reflector shield to reflect light emitted therefrom in order to achieve the desired illumination.

The conventional lamps, in general, consume more energy and expect shorter service life than LED lamps do.

The light beams of LEDs are known to have more condensed than do conventional light sources. But till recently, the luminosity of LEDs has been pretty limited, thus confining their use to such devices as signal lights, tail lights of vehicles, decorative lights, etc., which requires relatively low brightness. Fortunately, with the invention of blue light LED, and prices of LED steep depreciation, both of them prompt the development of the high brightness white light LED and their related applications. Particularly in the nowadays, when reducing energy consumption and carbon emission has become a major world issues. Governments around the world are encouraging people to replace their incandescent lighting with LED lighting, which is expected to become the mainstream of the market in the foreseeable future. Also called cold-cathode, LEDs are so different from conventional incandescent lights. They consume less energy and, longer service life time e.g. several tens of thousands of hours if they get adequate heat dissipation during lighting. By contrast, incandescent light bulbs usually last only about one thousand hours, while compact fluorescent bulbs, although lasting a bit longer, can only last up to a few thousand hours.

Unfortunately, the power of a single LED, even a so called high-power or high-brightness one, is usually a few watts only; the lighting generated is thus far from being adequate for most illumination needs. As a result, LED lighting devices often have tens of LEDs crowed in an rectangular array or a circular array mounted on predetermined curved board at in several light tube (light bars) side by side and with each light tube usually consisting of ten or more LED chips in several rows

One can easily imagine that, with tens of LED chips crowded in a closed space, the LEDS will soon suffer from overheating and even premature degradation. To avoid that, larger plane area or space to position the LED chips than that of conventional lighting devices is usually required. Besides, most LED lighting devices are designed for indoor use only. They do not take such natural ambient factors as rain, storms.

Particularly, in summer the island countries around the western coast of Pacific Ocean, e.g, Japan, Taiwan, and Philippine islands may suffer from several of typhoons invasions. A mid-class typhoon, e.g. level 12-15 gusty wind may bring the maximum sustain surface wind speed up to 32.7 to 50 m/s. for illuminative range up to 15 m, a street LED device has a planar area up to 1500 cm² is in common. The larger area needs, the more spectacular wind power may suffer. Thus a fastening member of the outdoor lighting devices must be strong enough to firmly fix it on the lamp post.

According to an embodiment of conventional method, the fastening member of street LED lighting device is similar to a halogen street lamp by having a sleeve directly holding an ends of a lamp post with several bolts to fasten them together.

In another embodiment, the sleeve is composed of an upper-half sleeve, and lower-half sleeve, respectively, mounted on an upper and a lower covers of the LED device. While assembling, the upper cover is engaged with the lower cover and with the upper part of the sleeve and the lower part of the sleeve holds on the lamp post associated with several bolts to fasten them together.

According to above embodiments, one internal diameter of the sleeve is just match one size of end lamp post. However, the specification of the lamp post in different countries or districts may usually differ. As a result, to cope with different sizes of the lamp post, more developing costs are usually necessary. More seriously, the upper cover or lower cover may also affect the design blue print due to change the inner diameter of the sleeve.

As forgoing drawback of the prior art, an object of the present invention is to disclose a fastening member for LED lighting device with lower cost and capable of cope with varies sizes of the end of lamp posts by just one internal size of sleeve associated with jaws, which may have different sizes to engage the end of lamp post.

### SUMMARY OF THE INVENTION

The present invention disclosed a fastening member for firmly fasten a street light device on a lamp post is disclosed, The fastening member comprises a sleeve formed integrated with a lower cover of said street light device, an upper jaw, a lower jaw and a plurality of bolts. The sleeve formed with a plurality of first thread-holes and a first through-hole at an upper portion and a plurality of second through-holes and a second thread-hole at a lower portion therein. The upper jaw and the lower jaw are placed in the hollow of the sleeve and preinstalled in by using the bolts screwed the thread-holes of the upper jaw and the lower jaw. Another bolts screwed on the first-thread-holes and the second thread-hole in advance. While installing the light device on the lamp post, the bolts screwed on the first-thread-holes and the second thread-hole are tighten.

Furthermore, an inner surface of a lower portion of the sleeve further has a sliding track and a convex surface of said lower jaw has a sliding groove corresponding to the track so that the lower jaw can be easier to position. The concave surface of the upper jaw and the lower jaw are also formed with multi-grooves along the axial direction of the sleeve so as to increase friction force against the lamp post and a water draining function too.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a front view of a partial portion lighting device of the present invention;

FIG. 2 shows a side view of the upper jaw and lower jaw according to the present invention;

FIG. 3 is a side view of lighting device according to the present invention;

FIG. 4 is top view of a partial portion of the lower cover according to the present invention.

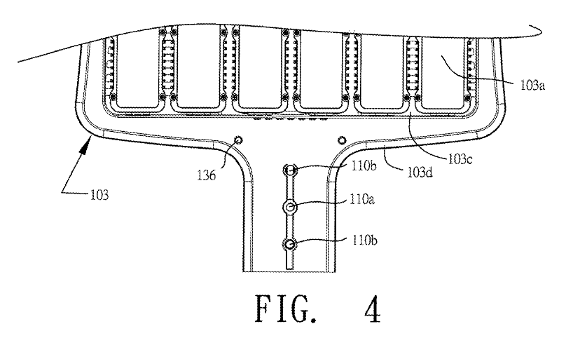

### DETAILED DESCRIPTION OF THE INVENTION

As forgoing description, an outdoor lighting device such as a street LED device may has a planar area at least up to 1500 cm² for an illuminative radius up to 15 m, as a result, it is inferior to withstand windstorms. Thus a fastening member of the outdoor lighting devices must be strong enough to firmly fix it on the lamp post.

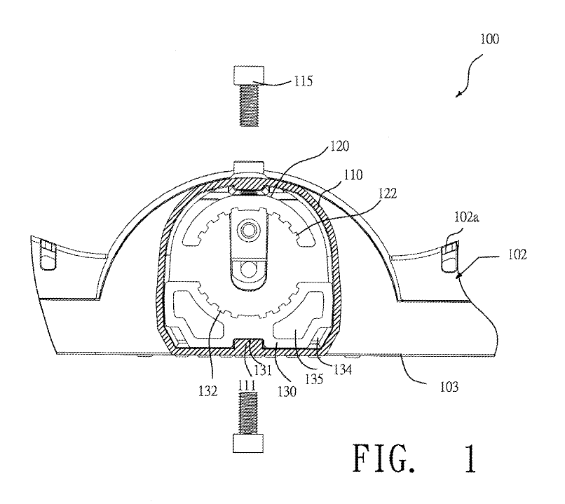

According a preferred embodiment of the present invention, the fastening member is very strong and has rain-water draining out function. Referring to FIG. 1, a partial portion of a street lighting device viewing from the front side is shown. The upper cover has a pattern of multiple slits 102a provided for air convection. The corresponding lower cover having space for installation of light tubes and formed with a sleeve 110 at one side of the lower cover. The sleeve 110 has an internal radius much larger than almost all of known sizes of the end portion of the lamp post so that a single size of the sleeve 110 can accommodate various sizes of lamp posts. An upper jaw 120 and a lower jaw 130 are placed in the hollow portion of the sleeve 110. A couple of bolts are used to tight the jaws 120, 130 on the end of lamp post together. The things that lighting device manufacturers must to do are to make the curvature of the jaws 120, 130 matched with the lamp post. No extra design scheme for the lighting device is necessary except the curvature of the jaws must be varied in accordance with the lamp posts. The sizes of the lamp-posts may be different according to the districts and countries.

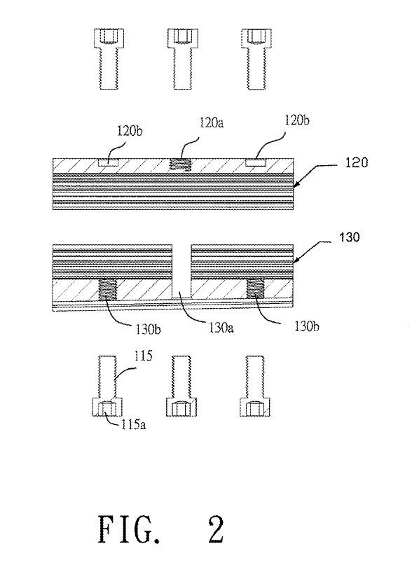

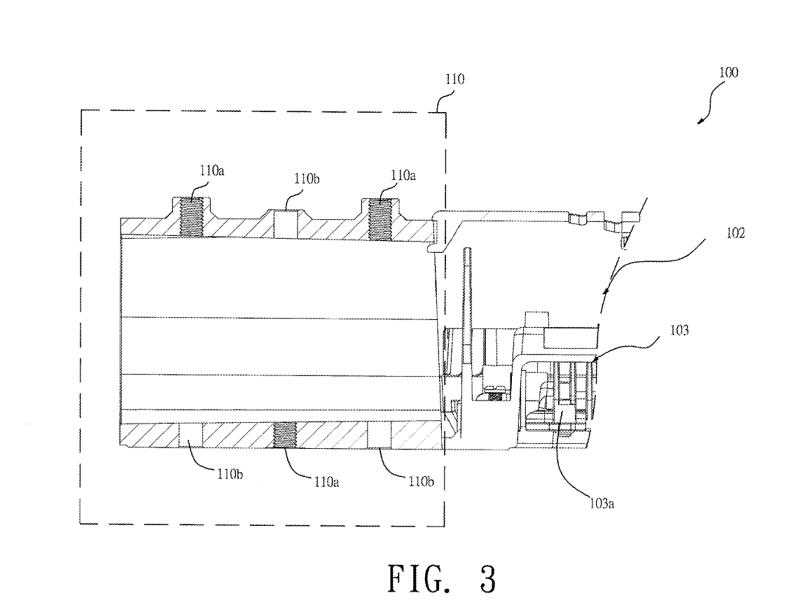

To facilitate a worker to setup the lighting device on the bent end of lamp post, the upper jaw 120 and the lower jaw 130 are disposed in the sleeve 110 in advance. Please refer to FIG. 2, the side view along the longitudinal direction of the sleeve 110 having the upper jaw 120 and the lower jaw 130 set therein. In FIG. 3, it shows the upper cover 102 and the lower cover 103 integrated with the sleeve 110 and housing a LED light tube formed with heat dissipation fins thereon. The upper jaw 120 is formed with a thread-hole 120a and two blind holes 120b therein. In a corresponding area to the upper jaw, the sleeve 110 has one through-hole 110b and two thread-holes 110a formed therein

The lower jaw 130 is formed with two thread-holes 130b and one through-hole 130a. In a corresponding area to the lower jaw, the sleeve 110 has two through-holes 110b and one thread-hole 110 formed.

In addition, to save the time of alignment during installing the lower jaw 130 into sleeve 110, in the lower part of the inner surface of the sleeve 110 is formed with a sliding track 111 and the outer surface i.e., a convex surface of the lower jaw 130 is formed with a sliding groove 131 corresponding thereto. Thus the groove 131 of the lower jaw 130 can be slid through the track 111 of the sleeve 110. Alternatively, the positions of the sliding groove 131 and the sliding track 111 are swapped.

Before installing the lighting device onto the lamp post, a bolt 115 is screwed on the thread-hole 120a to hold the upper jaw 120 through the through-hole 110b of the sleeve 110. Two another bolts 115 are screwed on the thread-holes 110a of the sleeve 110 presented as a ready state.

Similarly, the lower jaw 130 is slid through the sliding track 111. Two bolts then hold the lower jaw 130 in the sleeve 110 through the through-hole 110a screwed on the thread-holes 130b. Another bolt 115 then is screwed on the thread-hole 110a into the through-hole 130b of the lower jaw 130 presented as a ready state. The forgoing bolts 115 may be a bolt with hexagonal head tap and/or with inner hexagonal head tap 115a.

While installing the LED light device, the bolt 115 screwed on the thread-hole 120a the upper jaw 120 is pulled up (along radial direction) so that the space spanned by the upper jaw 120 and the lower jaw 130 is more to accommodate and house the bent end of the lamp post. The upper jaw 120 together with the lower jaw 130 will then be firmly fasten on the bent end of the lamp post by means of two other bolts 115 on the thread-holes 110a closely engaged on the two blind holes 120b and one another bolt 115 screwed on the thread-hole 110a through the through-hole 130a to touch the lamp post.

Moreover, the inner (concave) surfaces of the lower jaw 130 and the upper jaw 120 is formed with multiple drainage grooves thereon to direct rain water flowing out and increase the friction against the lamp post.

Besides, the lower jaw 130 is not solid but has two pairs of holes 134 and 135, respectively formed at the two sides of the sliding groove 131 to drain residual rain water out.

The lower jaw 120 has a function of draining water out is necessary since to increase capability of air convection upper cover 102 of the light device versus the gaps between the light tubes the surface of the upper cover 102 has formed of multiple slits 102a. The multiple slits 102a are also become inlets of the rain water and drain water out from the gaps between the light tubes. The outer periphery of the lower cover 103 also formed with a ring of drainage trench 103d having two holes 136 formed therein to drain water. The rain water is firstly guided to the holes 136 and the residual is drained to the holes 134 and 135.

The benefits of the present invention:
1 The fastening member is composed of a sleeve, an upper jaw, a lower jaw, and bolts. The curvature of both jaws made is in accordance with the bent end of the lamp post. Thus the fastening member can withstand the strong winds.
2 In response to various districts may have versatile of lamp post, the fastening member can still be applied. The needs are just change the jaws without altering the sleeve. No alter the covers of the light device is necessary.
3 Since the upper jaw and the lower jaw together with several bolts are installed in the sleeve in advance, the thing only needed for a worker or engineer just pulls out the bolt 115 screwed on the thread-hole of the upper jaw 120 to increase the span space for housing the bent end of lamp post and then tighten the other bolts. Thus it is very convenient and easy to install the light device.
4 The fastening member contains water drainage function and thus it can be used in strict environments even the storm weather.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. A fastening member for firmly fasten a street light device on a lamp post, comprising:
a sleeve formed integrated with a lower cover of said street light device, said sleeve having a plurality of first thread-holes and a first through-hole formed at an upper portion and a plurality of second through-holes and a second thread-hole formed at a lower portion therein;
an upper jaw having a first curvature radius being small than that of said sleeve and formed with a plurality of blind holes and a thread-hole corresponding to said first thread-holes and said first through-hole, respectively;
a lower jaw having a second curvature radius being small than that of said sleeve and formed with a plurality of thread-holes and a through-hole corresponding to said second through-holes and said second thread-hole, respectively; and
a plurality of bolts provided for holding said upper jaw and said lower jaw in the sleeve by screwing said bolts, respectively, into said thread-hole of said upper jaw and said thread-holes of said lower jaw, and said bolts also screwed on said first thread-holes and said second thread-hole to present as a ready state.

2. The fastening member as in claim 1 wherein an inner surface of a lower portion of said sleeve further has a sliding track and a convex surface of said lower jaw has a sliding groove corresponding to said track so that said lower jaw can be easier to position.

3. The fastening member as in claim 1 wherein said lower jaw comprises holes at left and right side of said sliding groove.

4. The fastening member as in claim 1 wherein an inner surface of a lower portion of said sleeve further has a sliding groove and a convex surface of said lower jaw has a sliding track corresponding to said track so that said lower jaw can be easier to position.

5. The fastening member as in claim 1 wherein concave surfaces of said upper jaw and said lower jaw are formed with multiple grooves along an axis direction of said sleeve.

6. The fastening member as in claim 1 wherein while installing said light device, said bolts screwed on said first thread-holes and said second thread-hole are tightened so that said bolts in said first thread-holes are tightened to said blind-holes and on said second thread-hole is touch said lamp post so that said upper jaw and said lower jaw firmly fastened said lamp post.

7. A method for a fastening member firmly tighten on a street light device on a lamp post, comprising the steps of:
provided a sleeve formed integrated with a lower cover of said street light device, said sleeve having a plurality of first thread-holes and a first through-hole formed at an upper portion and a plurality of second through-holes and a second thread-hole formed at a lower portion therein;
provided an upper jaw having a plurality of blind-holes and a thread-hole corresponding to said first thread-holes and said first through-hole;
provided a lower jaw having a plurality of thread-holes and a through-hole corresponding to said second through-holes and said second thread-hole;
screwing a plurality of bolts on said thread-holes of said upper jaw and said lower jaw to hold said upper jaw and said lower jaw;
screwing a plurality of bolts on said first thread-holes and said second thread-hole;
pulled up said bolt screwed on said thread-hole of said upper jaw;
said sleeve housing said lamp post; and
screwing said bolts on said first thread-holes and said second thread-hole and tightening so as to tighten said light device on said lamp post.

8. The method as in claim 7 wherein an inner surface of a lower portion of said sleeve further has a sliding track and a convex surface of said lower jaw has a sliding groove corresponding to said track so that said lower jaw is slid on said slide track.

9. The method as in claim 7 as in claim 1 wherein concave surfaces of said upper jaw and said lower jaw are formed with multiple grooves along an axis direction of said sleeve.
